(19) United States
(12) Patent Application Publication
(10) Pub. No.: US 2021/0185404 A1
(43) Pub. Date: Jun. 17, 2021

(54) METHOD AND APPARATUS TO NOTIFY AND VIEW EMERGENCY ALERT SYSTEM MESSAGES ON MOBILE DEVICES

(71) Applicant: ARRIS Enterprises LLC, Suwanee, GA (US)

(72) Inventors: Kaliraj KALAICHELVAN, San Diego, CA (US); William P. FRANKS, San Diego, CA (US)

(73) Assignee: ARRIS Enterprises LLC, Suwanee, GA (US)

(21) Appl. No.: 17/117,582

(22) Filed: Dec. 10, 2020

Related U.S. Application Data
(60) Provisional application No. 62/946,933, filed on Dec. 11, 2019.
(60) Provisional application No. 63/046,485, filed on Jun. 30, 2020.

(51) Int. Cl. H04N 21/488; H04N 21/4363; H04N 21/2385; H04W 4/90

(52) U.S. Cl. CPC H04N 21/4882; H04W 4/90; H04N 21/2385; H04N 21/43637

(57) ABSTRACT

A method, a set-top box, and a non-transitory computer readable medium are disclosed to notify and view Emergency Alert System messages on a mobile device. The method includes receiving, on a set-top box, an Emergency Alert System message; storing, on the set-top box, the Emergency Alert System message; and sending, from the set-top box to one or more mobile devices, a notification that the set-top box has received the Emergency Alert System message.

### CROSS-REFERENCE TO RELATED APPLICATIONS

This application claims the benefit of U.S. Provisional Patent Application Ser. No. 62/946,933, filed on Dec. 11, 2019, and U.S. Provisional Patent Application Ser. No. 63/046,485, filed on Jun. 30, 2020, the entire content of both of which is hereby incorporated herein by reference.

### TECHNICAL FIELD

The present disclosure generally relates to a method and an apparatus to notify and view emergency alert system (EAS) messages on mobile devices.

### BACKGROUND

Cable service providers, which are also referred to as Multiple System Operators (“MSO”), or any communication or content distribution business that operates through a cable network, renders its services to its subscribers. The services can include, but are not limited to, different subscription plans for broadband Internet access and telephony. In order to consume these services, subscribers connect to a private network owned (or co-owned or rented) by the broadband cable operator which is implemented according to the Data Over Cable Service Interface Specification (DOCSIS) standard.

Currently, the present infrastructure and digital set-top box's Federal Communications Commission (FCC) compliance can enable the notification and viewing of Emergency Alert System (EAS) messages on a viewing device like a television when the EAS message is sent. This may be adequate when an individual is actively viewing or in proximity to of the viewing device, for example, a television. However, if the individual is not watching the viewing device, and/or out of the area, or alternatively the viewing device is a mobile device that is not currently receiving cellular service and is a WiFi only type device, the individual will not receive the message being delivered by the EAS message, which can include, for example, the President of the United States to address the country via radio and television stations, in the event of a national emergency, and more commonly used to distribute information regarding imminent threads to public safety, such as severe weather situations, for example, flash floods and tornadoes, AMBER Alerts of child abductions, and civic emergencies.

It would be desirable to have a method that enables the viewer to be notified on his mobile device, for example, a phone or tablet, of an EAS occurrence and provide a way to view the EAS message on their mobile device.

### SUMMARY

In accordance with exemplary embodiments, a method and apparatus to notify and view Emergency Alert System (EAS) messages on mobile devices that leverages the existing infrastructure and improves on digital set-top boxes in achieving this functionality, and which can provide, for example, users or consumers with EAS messages when outside of their home and/or traveling outside of the local area to provide the notification to a user that would not normally receive it.

In accordance with an aspect, a method is disclosed to notify and view Emergency Alert System messages on a mobile device, the method comprising: receiving, on a set-top box, an Emergency Alert System message; storing, on the set-top box, the Emergency Alert System message; and sending, from the set-top box to one or more mobile devices, a notification that the set-top box has received the Emergency Alert System message.

In accordance with another aspect, a set-top box configured to notify a mobile device of an Emergency Alert System message is disclosed, the set-top box comprising: a communications interface configured to receive the Emergency Alert System message; a memory configured to store the Emergency Alert System message; and a processor configured to: send a notification that the set-top box has received the Emergency Alert System message to one or more mobile devices paired with the set-top box.

In accordance with an aspect, a non-transitory computer readable medium having instructions operable to cause one or more processors to perform operations comprising: receiving, on a set-top box, an Emergency Alert System message; storing, on the set-top box, the Emergency Alert System message; and sending, from the set-top box to one or more mobile devices, a notification that the set-top box has received the Emergency Alert System message.

### BRIEF DESCRIPTION OF THE DRAWINGS

FIG. 1 is an illustration of an exemplary network environment for a method and apparatus to notify and view Emergency Alert System (EAS) messages on one or more mobile devices.

FIG. 2 is an exemplary hardware architecture for an embodiment of a computer system in accordance with an embodiment.

FIG. 3 is a flow chart of a method to notify and view Emergency Alert System (EAS) messages on one or more mobile devices in accordance with an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

### System to Notify and View Emergency Alert System (EAS) Messages on Mobile Devices

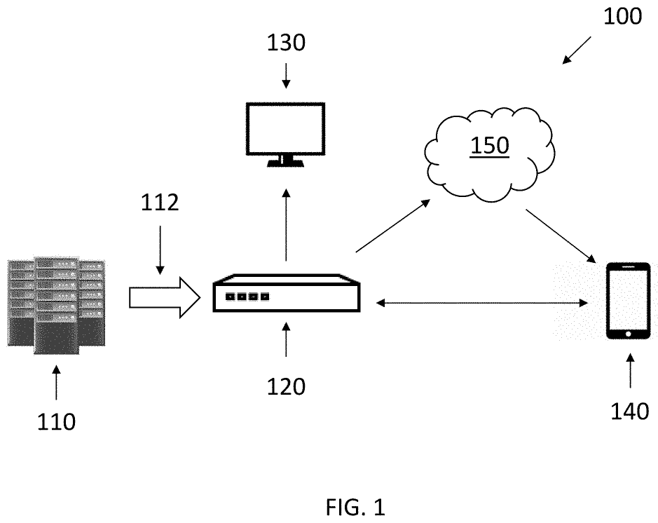

FIG. 1 is a block diagram illustrating an example network environment 100 to notify and view emergency alert system (EAS) messages on one or more mobile devices 140. In embodiments, a cable provider (or MSO) server 110 can provide, for example, media content, for example, video and/or data services to a set-top box (STB) 120, for example, an in-home digital set-top box. The set-top box 120 may communicate with one or more remote media play devices 130 over a local network (for example, a local area network (LAN), a wireless local area network (WLAN), a personal area network (PAN), etc.) and/or wired, for example, to a television, and may communicate with an upstream wide area network (WAN) to the cable provider server 110.

The cable provider server 110 can provide high-bandwidth data transfer, for example, media content, cable television and broadband internet access, for example, to the in-home digital set-top box 120. In addition, the cable provider server 110 provides the infrastructure that enables the digital set-top box 120 to receive the notification and viewing of Emergency Alert System (EAS) messages. However, if the individual is not watching the viewing device and/or out of the area, the individual will not receive the message being delivered by the EAS message, which can include, for example, information regarding imminent threads to public safety, such as severe weather situations, for example, flash floods and tornadoes, America's Missing: Broadcast Emergency Response (AMBER) Alerts of child abductions, and civic emergencies.

In accordance with exemplary embodiment, a method and apparatus are disclosed that provides improves the capability of the in-home digital set-top box 120 to receive or listen for EAS messages even when no media or content is being viewed, for example, on the one or more remote media play devices 130. In accordance with an embodiment, when EAS message is received on the set-top box 120, the EAS message is composed of four parts: a digitally encoded Specific Area Message Encoding (SAME) header, an attention signal, an audio announcement, and a digitally encoded end-of-message marker. The set-top box 120 can be configured to record specific information in connection with the EAS message, which can include but not limited to EAS content (for example, the imminent threat to public safety), a time of occurrence, a rate of occurrence, and severity. As part of the handling of the EAS message, the set-top box 120 can be configured to notify the occurrence and content of the EAS message to one or more mobile devices 140. In accordance with an embodiment, the one or more mobile devices 140 can be configured to retrieve the EAS message and play the content of the EAS message.

The current radio frequency (RF) cable infrastructure for delivering EAS messages is over a quadrature amplitude modification (QAM) pipe 112 for instance. In accordance with an embodiment, the set-top box 120 can always be tuned to the QAM frequency and can wait for and receive EAS messages once sent by the EAS system and become availability. When an EAS message is delivered to the set-top box 120, the EAS message is parsed, identified as an emergency message and recorded by the set-top box 120. A notification can be sent to the one or more mobile devices 140 when the parsed EAS message is recognized as such, and a store of appropriate contact points (e.g., mobile numbers to receive audio, video or texts as selected through an interface on the set-top box 120 (e.g., commonly housed or through a remote control device) and transmitted to a cloud server 150. In accordance with an embodiment, the one or more mobile devices 140 can be reachable via, for example, a notification server 150, for example, a “cloud” notification server or directly based on a wireless network protocol, for example, based on IEEE 802.11 (e.g., WiFi) or Long-term Evolution (LTE) 160, typically through a cellular network, via WiFi or nearly any other network structure (not shown). In accordance with an embodiment, the one or more mobile devices 140 can receive a notification that an EAS message has been received on the set-top box 120, and can automatically retrieve the EAS content directly from the set-top box 120 via WiFi or other direct communications, or back through a cellular system or the like for playback automatically or at a viewer's request. For example, the Emergency Alert System (EAS) message can be received and display immediately, for example, on the graphical user interface (GUI) or screen of the one or more mobile devices, or an audio or video alert or playback of the Emergency Alert System (EAS) message can be delivered to user via the mobile device. Alternatively, the Emergency Alert System (EAS) message can be delivered via a text message, an email or alert that can be viewed or listed to at a later time based on the desires of the user of the mobile device. In accordance with an embodiment, the one or more mobile devices can receive an entirety of the Emergency Alert System message, the entirety of the Emergency Alert System message including a time of occurrence, a rate of occurrence, and/or severity of the Emergency Alert, or a notification an Emergency Alert System message has been issued and which can be retrieved upon request of the user of the one or more mobile devices.

In accordance with an exemplary embodiment, the one or more mobiles devices 140 may be any type of computing device configured to connect via a wireless network, for example, wireless network utilizing an IEEE 802.11 specification, including a smart phone, a smart TV, a computer, a mobile device, a tablet, or any other device operable to communicate wirelessly with the set-top box 120, or alternatively, the set-top box 120 can communicate with the one or more mobile devices via Long-term Evolution (LTE), for example, the standard for wireless broadband communication for mobile device and data terminals, based on the Global System for Mobile Communications/Enhanced Data rates for GSM Evolution (GSM/EDGE) and Universal Mobile Telecommunications Systems/High Speed Packet Access (UMTS/HSPA) technologies.

### Computer System Architecture

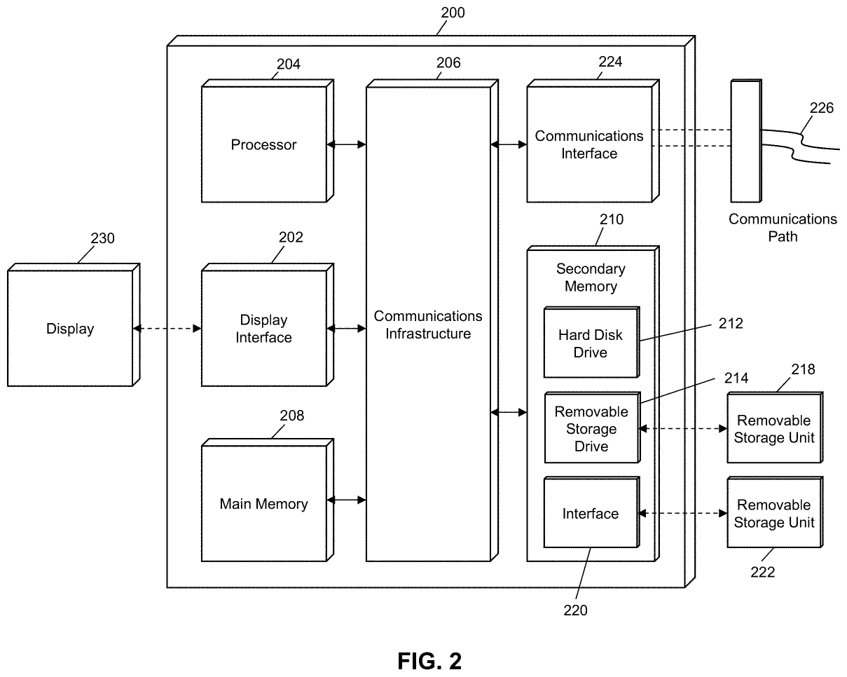

FIG. 2 illustrates a representative computer system 200 in which embodiments of the present disclosure, or portions thereof, may be implemented as computer-readable code executed on hardware. For example, the set-top box 120 and the one or more mobile devices 140 of FIG. 1 may be implemented in whole or in part by a computer system 200 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the presently described method and system.

If programmable logic is used, such logic may execute on a commercially available processing platform configured by executable software code to become a specific purpose computer or a special purpose device (for example, programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 218, a removable storage unit 222, and a hard disk installed in hard disk drive 212.

Various embodiments of the present disclosure are described in terms of this representative computer system 200. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

A processor device 204 may be processor device specifically configured to perform the functions discussed herein. The processor device 204 may be connected to a communications infrastructure 206, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 200 may also include a main memory 208 (e.g., random access memory, read-only memory, etc.), and may also include a secondary memory 210. The secondary memory 210 may include the hard disk drive 212 and a removable storage drive 214, such as a floppy disk drive, a magnetic tape drive, an optical disk drive, a flash memory, etc.

The removable storage drive 214 may read from and/or write to the removable storage unit 218 in a well-known manner. The removable storage unit 218 may include a removable storage media that may be read by and written to by the removable storage drive 214. For example, if the removable storage drive 214 is a floppy disk drive or universal serial bus port, the removable storage unit 218 may be a floppy disk or portable flash drive, respectively. In one embodiment, the removable storage unit 218 may be non-transitory computer readable recording media.

In some embodiments, the secondary memory 210 may include alternative means for allowing computer programs or other instructions to be loaded into the computer system 200, for example, the removable storage unit 222 and an interface 220. Examples of such means may include a program cartridge and cartridge interface (e.g., as found in video game systems), a removable memory chip (e.g., EEPROM, PROM, etc.) and associated socket, and other removable storage units 222 and interfaces 220 as will be apparent to persons having skill in the relevant art.

Data stored in the computer system 200 (e.g., in the main memory 208 and/or the secondary memory 210) may be stored on any type of suitable computer readable media, such as optical storage (e.g., a compact disc, digital versatile disc, Blu-ray disc, etc.) or magnetic storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 200 may also include a communications interface 224. The communications interface 224 may be configured to allow software and data to be transferred between the computer system 200 and external devices. Exemplary communications interfaces 224 may include a modem, a network interface (e.g., an Ethernet card), a communications port, a PCMCIA slot and card, etc. Software and data transferred via the communications interface 224 may be in the form of signals, which may be electronic, electromagnetic, optical, or other signals as will be apparent to persons having skill in the relevant art. The signals may travel via a communications path 226, which may be configured to carry the signals and may be implemented using wire, cable, fiber optics, a phone line, a cellular phone link, a radio frequency link, etc.

The computer system 200 may further include a display interface 202. The display interface 202 may be configured to allow data to be transferred between the computer system 200 and external display 230. Exemplary display interfaces 202 may include high-definition multimedia interface (HDMI), digital visual interface (DVI), video graphics array (VGA), etc. The display 230 may be any suitable type of display for displaying data transmitted via the display interface 202 of the computer system 200, including a cathode ray tube (CRT) display, liquid crystal display (LCD), light-emitting diode (LED) display, capacitive touch display, thin-film transistor (TFT) display, etc.

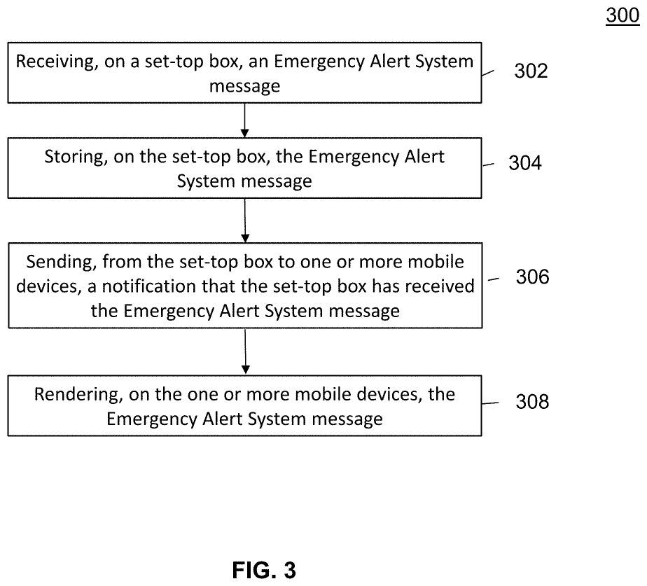

Computer program medium and computer usable medium may refer to memories, such as the main memory 208 and secondary memory 210, which may be memory semiconductors (e.g., DRAMs, etc.). These computer program products may be means for providing software to the computer system 200. Computer programs (e.g., computer control logic) may be stored in the main memory 308 and/or the secondary memory 210. Computer programs may also be received via the communications interface 224. Such computer programs, when executed, may enable computer system 200 to implement the present methods as discussed herein. In particular, the computer programs, when executed, may enable processor device 204 to implement the methods illustrated by FIGS. 1 and 3, as discussed herein. Accordingly, such computer programs may represent controllers of the computer system 200. Where the present disclosure is implemented using software executed on hardware, the software may be stored in a computer program product and loaded into the computer system 200 using the removable storage drive 214, interface 220, and hard disk drive 212, or communications interface 224.

The processor device 204 may comprise one or more modules or engines configured to perform the functions of the computer system 200. Each of the modules or engines may be implemented using hardware and, in some instances, may also utilize software executed on hardware, such as corresponding to program code and/or programs stored in the main memory 208 or secondary memory 210. In such instances, program code may be compiled by the processor device 204 (e.g., by a compiling module or engine) prior to execution by the hardware of the computer system 200. For example, the program code may be source code written in a programming language that is translated into a lower level language, such as assembly language or machine code, for execution by the processor device 204 and/or any additional hardware components of the computer system 200. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 200 to perform the functions disclosed herein. It will be apparent to persons having skill in the relevant art that such processes result in the computer system 200 being a specially configured computer system 200 uniquely programmed to perform the functions discussed above.

### Method to Notify and View Emergency Alert Message on Mobile Device

FIG. 3 is a flow chart 300 of a method to notify and view Emergency Alert System (EAS) messages on a mobile device in accordance with an embodiment. As shown in FIG. 3, in step 302, an Emergency Alert System message is received on a set-top box 120. In step 304, the Emergency Alert System message is stored, for example, recorded on the set-top box 120. In step 306, a notification is sent by from the set-top box 120 to one or more mobile devices 140 that the set-top box 120 has received the Emergency Alert System message. In step 308, the Emergency Alert System message is rendered or displayed on the one or more mobile devices 140.

In accordance with an embodiment, the set-top box is tuned to a quadrature amplitude modulation (QAM) frequency to receive the Emergency Alert System message, and the Emergency Alert System message is received on the set-top box over a quadrature amplitude modulation (QAM) pipe.

In accordance with another embodiment, the notification is sent from the set-top box to the one or more mobile devices using a notification server. In addition, the notification can be sent from the set-top box to the one or more mobile devices directly via WiFi, Long-term Evolution (LTE), or a cellular networks, for example, 2G, 3G, 5G, etc.

In accordance with an embodiment, a request is received from the one or more mobile devices on set-top box for Emergency Alert System content, and the Emergency Alert System content is sent to the one or more mobile devices. In accordance with another embodiment, the Emergency Alert System content, which can include content of the Emergency Alert Message, a time of occurrence, a rate of occurrence, and/or severity of the Emergency Alert Message with the notification is automatically send from the set-top box to the one or more mobile devices. In addition, the one or more mobile devices are paired with the set-top box to receive the notification that the set-top box has received the Emergency Alert System message.

Techniques consistent with the present disclosure provide, among other features, method and apparatus to notify and view emergency alert system (EAS) messages on a mobile device. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method to notify and view Emergency Alert System messages on a mobile device, the method comprising:
receiving, on a set-top box, an Emergency Alert System message;
storing, on the set-top box, the Emergency Alert System message; and
sending, from the set-top box to one or more mobile devices, a notification that the set-top box has received the Emergency Alert System message.

2. The method according to claim 1, further comprising:
tuning, the set-top box, to a quadrature amplitude modulation (QAM) frequency to receive the Emergency Alert System message; and
receiving, on the set-top box, the Emergency Alert System message over a quadrature amplitude modulation (QAM) pipe.

3. The method according to claim 1, further comprising:
sending, from the set-top box, the notification to the one or more mobile devices using a notification server.

4. The method according to claim 1, further comprising:
sending, from the set-top box, the notification to the one or more mobile devices directly via WiFi, Long-term Evolution (LTE), or a cellular network.

5. The method according to claim 1, further comprising:
receiving, on the set-top box, a request from the one or more mobile devices for Emergency Alert System content; and
sending, from the set-top box, the Emergency Alert System content to the one or more mobile devices.

6. The method according to claim 1, further comprising:
automatically sending, from the set-top box to the one or more mobile devices, the Emergency Alert System content includes content of the Emergency Alert Message, a time of occurrence, a rate of occurrence, and/or severity of the Emergency Alert Message with the notification.

7. The method according to claim 1, further comprising:
pairing the set-top box with the one or more mobile devices to receive the notification that the set-top box has received the Emergency Alert System message.

8. A set-top box configured to notify a mobile device of an Emergency Alert System message, the set-top box comprising:
a communications interface configured to receive the Emergency Alert System message;
a memory configured to store the Emergency Alert System message; and
a processor configured to:
send a notification that the set-top box has received the Emergency Alert System message to one or more mobile devices paired with the set-top box.

9. The set-top box according to claim 8, wherein
the processor of the set-top box is tuned to a quadrature amplitude modulation (QAM) frequency to receive the Emergency Alert System message; and
the Emergency Alert System message is received over a quadrature amplitude modulation (QAM) pipe.

10. The set-top box according to claim 8, wherein the processor is configured to:
send the notification to the one or more mobile devices via a notification server; and/or
send the notification to the one or more mobile devices directly via WiFi, Long-term Evolution (LTE), or a cellular network.

11. The set-top box according to claim 8, wherein the processor is configured to:
receive a request from the one or more mobile devices for Emergency Alert System content; and
send the Emergency Alert System content to the one or more mobile devices.

12. The set-top box according to claim 8, wherein the processor is configured to:
automatically send the Emergency Alert System content to the one or more mobile devices, the Emergency Alert System content including content of the Emergency Alert Message, a time of occurrence, a rate of occurrence, and/or severity of the Emergency Alert Message with the notification.

13. The set-top box according to claim 8, wherein the processor is configured to:
pair the set-top box with the one or more mobile devices to receive the notification that the set-top box has received the Emergency Alert System message.

14. A non-transitory computer readable medium having instructions operable to cause one or more processors to perform operations comprising:
receiving, on a set-top box, an Emergency Alert System message;
storing, on the set-top box, the Emergency Alert System message; and
sending, from the set-top box to one or more mobile devices, a notification that the set-top box has received the Emergency Alert System message.

15. The non-transitory computer readable medium according to claim 14, further comprising:
tuning, the set-top box, to a quadrature amplitude modulation (QAM) frequency to receive the Emergency Alert System message; and
receiving, on the set-top box, the Emergency Alert System message over a quadrature amplitude modulation (QAM) pipe.

16. The non-transitory computer readable medium according to claim 14, further comprising:
sending, from the set-top box, the notification to the one or more mobile devices using a notification server.

17. The non-transitory computer readable medium according to claim 14, further comprising:
sending, from the set-top box, the notification to the one or more mobile devices directly via WiFi, Long-term Evolution (LTE), or a cellular network.

18. The non-transitory computer readable medium according to claim 14, further comprising:
receiving, on the set-top box, a request from the one or more mobile devices for Emergency Alert System content; and
sending, from the set-top box, the Emergency Alert System content to the one or more mobile devices.

19. The non-transitory computer readable medium according to claim 14, further comprising:
automatically sending, from the set-top box to the one or more mobile devices, the Emergency Alert System content includes content of the Emergency Alert Message, a time of occurrence, a rate of occurrence, and/or severity of the Emergency Alert Message with the notification.

20. The non-transitory computer readable medium according to claim 14, further comprising:
pairing the set-top box with the one or more mobile devices to receive the notification that the set-top box has received the Emergency Alert System message.
